(19) United States
(12) Patent Application Publication
(10) Pub. No.: US 2008/0030026 A1
(43) Pub. Date: Feb. 7, 2008

(54) Pipe Coupling System

(76) Inventor: Joong-Won Cho, Chungcheongnam-do (KR)

Correspondence Address: PEARL COHEN ZEDEK LATZER, LLP, 1500 BROADWAY 12TH FLOOR, NEW YORK, NY, 10036, US

(21) Appl. No.: 10/588,731

(22) PCT Filed: Feb. 4, 2005
(86) PCT No.: PCT/KR05/00351

§ 371 Date: Jun. 22, 2007

(30) Foreign Application Priority Data
Feb. 9, 2004 (KR) 10-2004-0008511
Dec. 31, 2004 (KR) 20-2004-0037573

(51) Int. Cl. F16L 19/028

(52) U.S. Cl. 285/363

(57) ABSTRACT

The present invention provides a pipe coupling system in which a piping work can be simply and easily performed by coupling a pipe and a pipe fitting to each other with a screw and a sealing effect can be enhanced by providing a soft sealing ring coming in close contact with the surfaces of the pipe and the pipe fitting. The pipe coupling system comprises: a pipe (2) provided with a flange (4) which is formed by bending an end of the pipe (2) in a direction perpendicular to a circumferential surface thereof; a swivel nut (8) fitted into the pipe (2) such that a rear end of the swivel nut (8) is laked to the flange of the pipe (2) to prevent separation; a soft sealing ring (10) provided to come in close contact with the surface of the flange (4) of the pipe (2); and a pipe fitting of which a part of a circumferential surface is provided with a male screw (34) such that the male screw (34) is coupled to the swivel nut (8) fitted into the pipe (2) and of which an end surface coming in contact with the soft sealing ring (10) is provided with a support protrusion (35) such that a part of an inner surface of the soft sealing ring (10) coming in close contact with the end surface is supported by the support protrusion (35).

### TECHNICAL FIELD

The present invention relates to a pipe coupling system, and more particularly, to a pipe coupling system in which a piping work can be simply and easily performed by coupling a pipe and a pipe fitting to each other with a screw and a sealing effect can be enhanced by bringing a soft sealing ring into close contact with the surfaces of the pipe and the pipe fitting.

### BACKGROUND ART

In general, piping works mean arranging and coupling pipes for water supply, drainage, air-conditioning, heating, gas supply, etc. The pipe fittings used for coupling the pipes to each other includes unions, nipples, elbows, valves, and the like.

In the past, welding was mainly used to couple the pipes (specifically copper pipes) to the pipe fittings such as unions, valves, nipples, elbows, etc. However, in the case of welding, much skillful techniques were required for the welding, it was difficult to perform maintenance at the time of occurrence of defects or breakdowns, and the whole pipe might be replaced in certain cases. That is, at the time of the occurrence of defects or breakdowns in the pipes, parts other than the breakdown parts should be replaced together and discarded. Further, it is very difficult to perform the partial de-composition (separation) works because the welded portions or a part of the pipe should be cut. Furthermore, it is difficult to perform the works of interchanging parts and re-coupling the parts because a pipe should be cut in an accurate length and then welded again.

In the case of welding, when two-floor or more buildings such as apartments are constructed, tests for leakage or air-tightness should be performed after the piping works are completed. Therefore, it is difficult to find out defects and much time and cost are required for repairing the defects.

In the conventional pipes, since check valves for preventing the backward flow of fluids passing therethrough and flow control valves, gate valves, ball valves for controlling the flow rate are individually provided, the number of pipe fittings is increased, thereby complicating the piping works.

### DISCLOSURE OF INVENTION

### Technical Solution

The present invention is contrived to solve the above-mentioned problems. An object of the present invention is to provide a pipe coupling system in which a piping work can be simply and easily performed by coupling a pipe and a pipe fitting to each other with a screw and a sealing effect can be enhanced by providing a soft sealing ring coming in close contact with the surfaces of the pipe and the pipe fitting.

In addition, another object of the present invention is to provide a pipe coupling system in which a construction can be simplified, a space-utilization efficiency can be improved, and cost can be reduced, by using as a pipe fitting a one-touch check valve having both functions of a check valve and a flow control valve.

According to an aspect of the present invention, there is provided a pipe coupling system comprising: a pipe provided with a flange which is formed by bending an end of the pipe in a direction perpendicular to a circumferential surface thereof; a swivel nut fitted into the pipe such that a rear end of the swivel nut is locked to the flange of the pipe to prevent separation; a soft sealing ring provided to come in close contact with the surface of the flange of the pipe; and a pipe fitting of which a part of a circumferential surface is provided with a male screw such that the male screw is coupled to the swivel nut fitted into the pipe and of which an end surface coming in contact with the soft sealing ring is provided with a support protrusion such that a part of an inner surface of the soft sealing ring coming in close contact with the end surface is supported by the support protrusion.

The pipe fitting may include a union, a nipple, a valve, a strainer, an elbow, a T-shaped joint, a Y-shaped joint, a “+” (cross)-shaped joint, etc.

The flange of the pipe may be formed in a fold by outwardly expanding once the end of the pipe and may be formed in two folds by outwardly expanding the end of the pipe and then inwardly bending again the outwardly expanded end of the pipe.

The pipe fitting may include the one-tough check valve comprises: a valve body formed in a T shape which has an empty space so as to allow fluid to flow horizontally and which has male screws formed at both ends of a horizontal portion through which the fluid flows; a disk which is provided at one side of the valve body and which is rotatable about a disk fixing pin in the valve body so as to control the flow of fluid; a flow control spindle which is provided rotatably in a vertical portion of the valve body so as to open and close the disk with rotation thereof and of which a lower end is bent to one side; and an eccentric-axis cover which is eccentrically provided in the vertical portion of the valve body and which rotatably supports the flow control spindle.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view illustrating a pipe coupling system according to an embodiment of the present invention;

FIG. 2 is a cross-sectional view illustrating an assembling state of the pipe coupling system according to the embodiment of the present invention;

FIG. 3 is a diagram illustrating a utilizing state of the pipe coupling system according to the embodiment of the present invention;

FIG. 4 is a cross-sectional view illustrating an assembling system of a pipe coupling system according to another embodiment of the present invention;

FIG. 5 is a cross-sectional view illustrating a one-touch check valve of a pipe coupling system according to an embodiment of the present invention;

FIG. 6 is a cross-sectional view illustrating a utilizing state of the one-touch check valve of the pipe coupling system according to the embodiment of the present invention; and

FIG. 7 is a cross-sectional view illustrating an assembling state of a pipe coupling system according to another embodiment of the present invention.

### BEST MODE FOR CARRYING OUT THE INVENTION

Hereinafter, pipe coupling systems according to exemplary embodiments of the present invention will be described in detail with reference to the accompanying drawings.

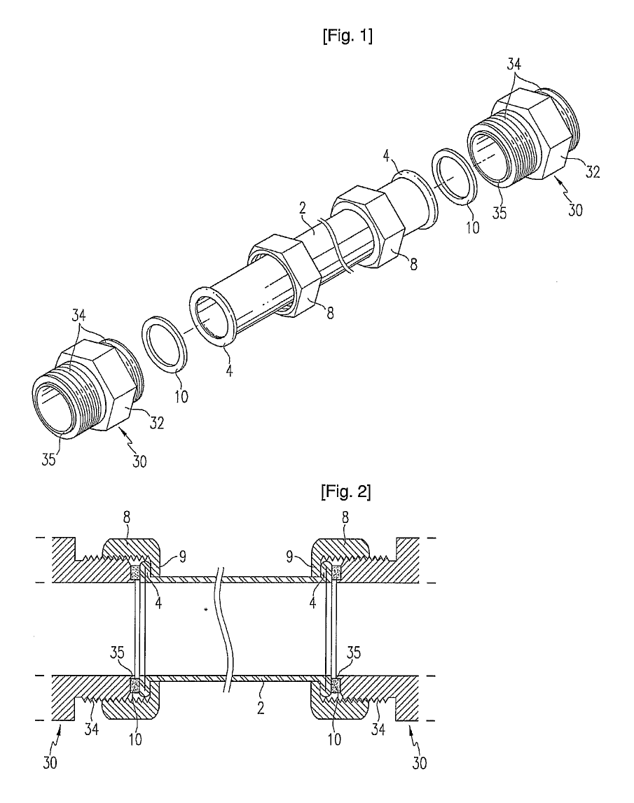

As shown in FIGS. 1 to 3, a pipe coupling system according to an embodiment of the present invention comprises a pipe 4 provided with flanges 4 which are formed by bending both ends of the pipe in a direction perpendicular to a circumferential surface thereof; swivel nuts 8 fitted into the pipe 2 such that a rear end of the swivel nut 8 is locked to the flanges 4 of the pipe 2 to prevent separation; soft sealing rings 10 provided to come in close contact with the surfaces of the flanges 4 of the pipe 2; and a pipe fitting of which parts of a circumferential surface are provided with a male screw 34 such that the male screws 34 are coupled to the swivel nuts 8 fitted into the pipe 2 and of which end surfaces coming in contact with the soft sealing rings 10 are provided with a support protrusion 35 such that a part of an inner surface of the soft sealing ring 10 coming in close contact with the end surface is supported by the support protrusion 35.

The flange 4 of the pipe 2 is formed by outwardly bending the end of the pipe 2.

For example, the flange 4 of the pipe 2 may be formed in a fold by outwardly expanding once the end of the pipe 2 as shown in FIG. 4 and may be formed in two folds by outwardly expanding the end of the pipe 2 and then inwardly bending again the outwardly expanded end of the pipe 2 as shown in FIG. 2.

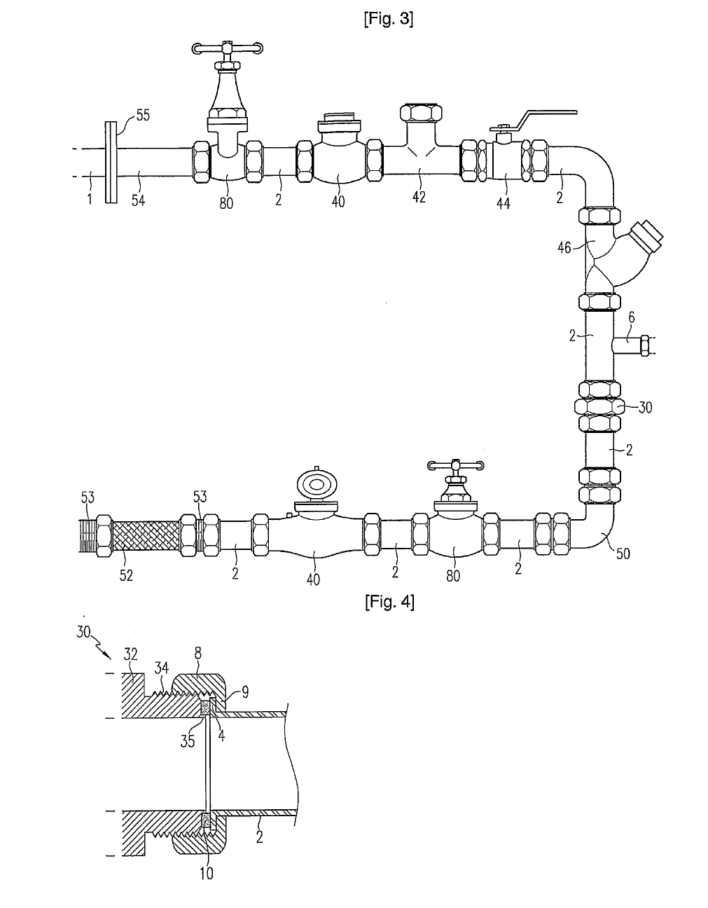

As shown in FIG. 3, the pipe 2 may be shaped for use in a variety of shaped such as a linear shape, an L shape, a T shape according to positions to be installed and piping designs.

A nipple 6 may be attached to the pipe 2 by welding as needed.

A copper pipe, a stainless steel pipe, and so on can be used as the pipe 2. In the case of the copper pipe of which the coupling work was conventionally performed by welding, since the piping work can be performed without the welding, the present invention is more effectively applied thereto.

As shown in FIG. 2, a stopper 9 is formed at the rear end of each swivel nut 8, and the stopper 9 is locked to the flange 4 of the pipe 2 to prevent separation thereof and brings the flange 4 of the pipe 2 into close contact with the pipe fitting.

The soft sealing ring 10 is made of an elastic material such as rubber, silicon, soft synthetic resin, etc.

The soft sealing ring 10 can be formed in a thin plate shape having both planes, and may be formed in a variety of shapes only if it can be deformed into a plate shape with force applied from both sides and can come in close contact with the flange 4 of the pipe 2 and the side surface of the pipe fitting.

A support protrusion 35 of the pipe fitting is protruded from its side surface by a height less than the thickness of the soft sealing ring 10. It is preferable that the support protrusion 35 has a height less than the minimum thickness of the soft sealing ring 10 when the soft sealing ring 10 is compressed, because a sufficient sealing effect can be obtained when the soft sealing ring 10 is compressed in maximum.

As shown in FIGS. 1 and 3, the pipe fitting can include a union 30, a gate valve 44, a one-touch check valve 80, an elbow 50, a T-shaped joint 42, a gauge 40, and the like.

Polygonal protrusions such as hexagonal protrusions 32, tetragonal protrusions, pentagonal protrusions, octagonal protrusions, etc. are preferably formed in the pipe fitting, such that a tool such as a spanner can be used to rotate the pipe fitting or restrict rotation of the pipe fitting at the time of fitting the pipe fitting to the pipe (see FIG. 1).

A flange joint 54, one end of which is provided with a flange 55 so as to enable the flange coupling with a main pipe 1 and the other end is provided with a male screw so as to be fitted with the swivel nut 8 fitted onto the pipe 2, may be used as the pipe fitting (see FIG. 3). In addition, a flexible pipe 52 made of a deformable and flexible material, both ends thereof are provided with male screws 53, may be used as the pipe fitting (see FIG. 3).

Although not shown as the pipe fitting in the figures, a variety of fittings such as a “+” (cross)-shaped joint, a nipple, a strainer, a stop valve, an angle valve, a gate valve, a security valve, and the like may be used as the pipe fitting.

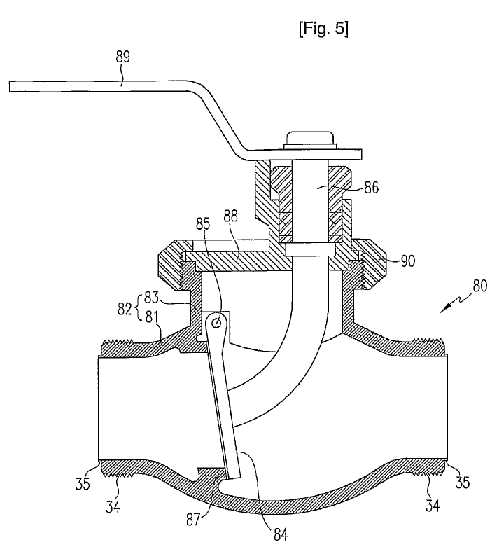

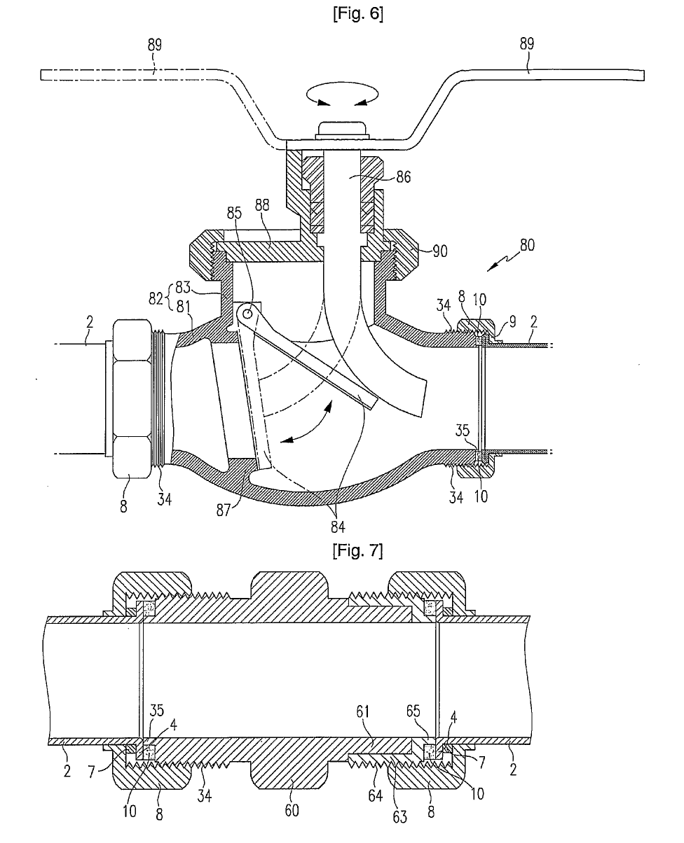

As shown in FIGS. 5 and 6, a one-touch check valve 80 as the pipe fitting comprises: a valve body 82 formed in a T shape which has an empty space so as to allow fluid to flow horizontally and which has male screws 34 formed at both ends of a horizontal portion 81 through which the fluid flows; a disk 84 which is provided at one side of the valve body 82 and which is rotatable about a disk fixing pin 85 in the valve body 82 so as to control the flow of fluid; a flow control spindle 86 which is provided rotatably in a vertical portion 83 of the valve body 82 so as to open and close the disk 84 with rotation thereof and of which a lower end is bent to one side; and an eccentric-axis cover 88 which is eccentrically provided in the vertical portion 83 of the valve body 82 and which rotatably supports the flow control spindle 86.

The inside of the valve body 82 is provided with an empty space so as to allow the fluid to flow horizontally, and a valve seat 87 coming in contact with the disk 84 is protruded from one end of the horizontal portion 81.

One end of the disk 84 is rotatably supported about the disk fixing pin 85 by the vertical portion 83 of the valve body 82.

A handle 89 is formed at the upper end of the flow control spindle 86.

The eccentric-axis cover 88 is fixed by fastening a fixing nut 90 to a male screw formed in the vertical portion 83.

In the one-touch check valve 80 having the above-mentioned structure, the male screws 34 are formed at both ends of the horizontal portion 81 of the valve body 82. Support protrusions 35 are formed at the ends of the male screws 34.

By rotating the flow control spindle 86, the one-touch check valve 80 allows the bent end thereof to bring the disk 84 into close contact with the valve seat 87, whereby the flow of fluid can be intercepted (see FIG. 5). By rotating the flow control spindle 86, the one-touch check valve 80 allows the bent end thereof to be separated from the disk 84, whereby the disk 84 can be freely detached from the valve seat 87 and can be rotated about the disk fixing pin 85 (see FIG. 6). Therefore, the flow of fluid passing through the horizontal portion 81 can be smoothly made from left to right in FIG. 6. That is, the one-touch check valve 80 serves as a flow control valve (gate valve, ball valve, etc) for controlling the flow rate in accordance with the degree of rotation of the flow control spindle 86 and also serves as a check valve which brings the disk 84 into close contact with the valve seat 87 with the pressure of fluid to intercept the flow of fluid.

As shown in FIG. 7, the pipe fitting may include a nipple 60 having one end provided with a male screw 34 and the other end provided with a coupling portion 61, and an insulating ring 63 which is compulsorily inserted and integrally fixed onto the coupling portion 61 of the nipple 60, which is made of an insulating material, and of which the circumferential surface is provided with a male screw 64.

A support protrusion 35 to be fitted with a soft sealing ring 10 is formed at an end of the male screw 34 of the nipple 60. In addition, a support protrusion 65 to be fitted with a soft sealing ring 10 is formed at an end of the insulating ring 63 opposite to the nipple 60.

Pipes 2 can be coupled to the nipple 60 and the insulating ring 63 using the swivel nuts 8.

A sealing member such as an O-ring 7 may be provided between the swivel nut 8 and the flange 4 of the pipe 2, thereby enhancing the sealing ability.

The insulating ring 63 may be made of an elastic material such as synthetic resin (polyacetal, etc), thereby bringing the insulating ring 63 into close contact with the coupling portion 61 with its elastic force.

When the insulating ring 63 described above is used, the flow of electricity along the pipe 2 can be intercepted in the way.

In the pipe coupling system according to the present invention described above, since the piping work can be performed using screws without performing the welding, any welder is not required. Therefore, it is possible to reduce the construction cost and to further decrease occurrence of a careless accident compared with the welding.

Since it is sufficient to decompose the swivel nuts at the time of occurrence of defects or breakdowns, the fittings can be partially interchanged, thereby facilitating the maintenance to reduce the maintenance cost.

When constructing two-floor or more buildings such as apartments, it is possible to perform a test for leakage or air-tightness in a unit of floors or pipe lines by fitting a pipe fitting having a closed end into an end of a pipe. Therefore, defects can be found out and repaired at any time. As a result, it is possible to improve construction quality and to reduce re-construction cost.

In the pipe coupling system according to the present invention described above, a soft sealing ring is closely interposed between a flange of a pipe and an end surface of a pipe fitting, thereby greatly enhancing the sealing effect. By forming the support protrusions locked to the soft sealing rings at the end surfaces of the pipe fittings, it is possible to easily perform the fitting and positioning works of the soft sealing rings and to prevent the separation of the soft sealing rings from the pipe fittings.

By forming the flange of the pipe in two folds to be perpendicular to the circumferential surface, the flange of the pipe can come in close contact with the swivel nut. As a result, it is not necessary to provide an additional sealing member such as an O-ring, thereby reducing the number of parts and greatly enhancing the strength thereof.

In addition, in the pipe coupling system according to the present invention, since one pipe fitting can performs two functions of a flow control valve (gate valve, ball valve, etc) and a check valve by employing the one-touch check valve, the piping work can be simplified and the installing space thereof can be reduced. Therefore, it is possible to reduce the construction cost and to enhance a space-utilization efficiency.

Furthermore, in the pipe coupling system according to the present invention, since the leakage and flow of electricity along the pipe can be intercepted in the way using the insulating ring as a pipe fitting, the present invention can be applied to a field requiring electrical security.

Although the exemplary embodiments of the present invention have been described the present invention is not limited to the exemplary embodiments, but may be modified in various forms without departing from the scope of the appended claims, the detailed description, and the accompanying drawings of the present invention. Therefore, it is natural that such modifications belong to the scope of the present invention.

1. A pipe coupling system comprising:
a pipe provided with a flange which is formed by bending an end of the pipe in a direction perpendicular to a circumferential surface thereof;
a swivel nut fitted into the pipe such that a rear end of the swivel nut is locked to the flange of the pipe to prevent separation;
a soft sealing ring provided to come in close contact with the surface of the flange of the pipe; and
a pipe fitting of which a part of a circumferential surface is provided with a male screw such that the male screw is coupled to the swivel nut fitted into the pipe and of which an end surface coming in contact with the soft sealing ring is provided with a support protrusion such that a part of an inner surface of the soft sealing ring coming in close contact with the end surface is supported by the support protrusion.

2. The pipe coupling system of claim 1, wherein the flange of the pipe is formed by outwardly expanding once the end of the pipe.

3. The pipe coupling system of claim 1, wherein the flange of the pipe is formed in two folds by outwardly expanding the end of the pipe and then inwardly bending again the outwardly expanded end of the pipe.

4. The pipe coupling system of claim 1, wherein the swivel nut is provided at a rear end with a stopper which is locked to the flange of the pipe to prevent separation therefrom and which brings the flange of the pipe into close contact with the pipe fitting at the time of screwing to the pipe fitting.

5. The pipe coupling system of claim 1, wherein the soft sealing ring is formed in a thin plate shape having both planes.

6. The pipe coupling system of claim 5, wherein the support protrusion of the pipe fitting is protruded from the side surface of the pipe fitting by a height smaller than the thickness of the soft sealing ring.

7. The pipe coupling system of claim 1, wherein the pipe fitting includes one or more selected from a union, a nipple, a gate valve, a one-touch check valve, an elbow, a T-shaped joint, a Y-shaped joint, a gauge, a flexible pipe, a “+” (cross)-shaped joint, a strainer, a stop valve, an angle valve, a gate valve, and a security valve.

8. The pipe coupling system of claim 7, wherein the one-tough check valve comprises:
a valve body formed in a T shape which has an empty space so as to allow fluid to flow horizontally and which has male screws formed at both ends of a horizontal portion through which the fluid flows;
a disk which is provided at one side of the valve body and which is rotatable about a disk fixing pin in the valve body so as to control the flow of fluid;
a flow control spindle which is provided rotatably in a vertical portion of the valve body so as to open and close the disk with rotation thereof and of which a lower end is bent to one side; and
an eccentric-axis cover which is eccentrically provided in the vertical portion of the valve body and which rotatably supports the flow control spindle.

9. The pipe coupling system of claim 8, wherein a valve seat coming in contact with the disk is protruded at one side within the horizontal portion of the valve body.

10. The pipe coupling system of claim 8, wherein the eccentric-axis cover is fixed to the vertical portion of the valve body by fitting a fixing nut to a male screw formed in the vertical portion.

11. The pipe coupling system of claim 1, wherein the pipe fitting includes:
a nipple of which one end is provided with a male screw and the other end is provided with a coupling portion; and
an insulating ring which is compulsorily inserted and integrally fixed onto the coupling portion of the nipple, which is made of an insulating material, and of which the circumferential surface is provided with a male screw.

12. The pipe coupling system of claim 1, wherein a sealing member capable of enhancing a sealing ability is interposed between the swivel nut and the flange of the pipe.
